(19) United States
(12) Patent Application Publication
(10) Pub. No.: US 2009/0183677 A1
(43) Pub. Date: Jul. 23, 2009

(54) TEMPERATURE CONTROL DEVICE AND PROCESSING APPARATUS USING THE SAME

(75) Inventors: Caizhong Tian, Hyogo (JP); Kiyotaka Ishibashi, Hyogo (JP); Toshihisa Nozawa, Hyogo (JP)

Correspondence Address: PEARNE & GORDON LLP, 1801 EAST 9TH STREET, SUITE 1200, CLEVELAND, OH, 44114-3108, US

(73) Assignee: TOKYO ELECTRON LIMITED, Tokyo (JP)

(21) Appl. No.: 12/357,493

(22) Filed: Jan. 22, 2009

(30) Foreign Application Priority Data
Jan. 22, 2008 (JP) 2008-011728

(51) Int. Cl. B05C 9/14

(52) U.S. Cl. 118/667; 236/20 R; 118/666

(57) ABSTRACT

Provided are a temperature control device capable of performing a temperature control of, e.g., a chamber wall of a processing apparatus with a high precision; and a processing apparatus using the same. The temperature control device 50 includes a plurality of heater units 51 for heating each of a multiplicity of zones 55 into which a wall portion of a housing 2 of a chamber 1 is divided; a multiplicity of heater power supplies 52 for supplying power to each of the plurality of heater units 51; a number of thermocouples 53 for measuring the temperature of each of the multiplicity of zones 55; and a plurality of controllers 54 for controlling a corresponding power supply unit by an ILQ control based on a signal from each temperature sensor to set a temperature of a corresponding zone to a preset target temperature.

### FIELD OF THE INVENTION

The present invention relates to a temperature control device for use in a processing apparatus for performing a process accompanied by heat such as a plasma process on a target object such as a semiconductor wafer or the like; and the processing apparatus using the temperature control device.

### BACKGROUND OF THE INVENTION

Conventionally, for example, in a manufacturing process of a semiconductor device, various processes such as etching, ashing, film formation, and the like are performed on a semiconductor wafer (hereinafter, simply referred to as a “wafer”) which is a target object to be processed. These processes are performed by mounting the wafer on a mounting table in a chamber and controlling the temperatures of the mounting table, a chamber housing, and so forth. Especially, in case of a film forming process, since a control of deposition on a housing wall portion constituting the chamber is critical, a highly precise temperature control is required so as to prevent occurrence of deposition.

Such temperature control has been conventionally carried out by a PID control (see, for example, Patent Document 1) The PID control is a feedback control by which a control of an input value is conducted based on three factors: a difference between a current value and a target value, and an integral thereof and a derivative thereof. The PID control does not necessitate a control object model.

When performing the temperature control by the PID control, however, problems of overshoot and hunting occur if sensitivity to the difference is increased. Accordingly, setting time is required to adjust the current temperature to the target temperature. On the contrary, if the sensitivity is lowered, response is slowed down. Accordingly, it also takes setting time so that it is difficult to adjust the current temperature to the target temperature promptly. Further, since the PID parameters can be chosen arbitrarily, control results may be varied depending on the parameter choice. Moreover, since the control is performed based on the difference between the target temperature and the actual temperature, the response characteristic is poor and a dynamic control error becomes a problem.

Furthermore, with the recent trend of the scale-up of the processing apparatus caused by the increase of a wafer size, a chamber size has also increased, so that the temperature control is attempted in multiple channels. However, when performing the temperature control by such multi-channel PID control, there may occur problems such as temperature non-uniformity between the channels or interference between the channels. As a result, it becomes difficult to perform the temperature control with a high precision.

### Patent Document 1 Japanese Patent Laid-open Publication No. 2003-005802

### BRIEF SUMMARY OF THE INVENTION

In view of the foregoing, the present invention provides a temperature control device capable of performing a temperature control of, e.g., a chamber wall of a processing apparatus with a high precision; and a processing apparatus using the same.

In accordance with a first aspect of the present invention, there is provided a temperature control device, for use in a processing apparatus for performing a preset process on a substrate accommodated in a processing chamber, for performing a temperature control of a predetermined portion of the processing chamber or a predetermined member therein as a control target object, the device including: a heater unit for heating the control target object; a power supply unit for supplying power to the heater unit; a temperature sensor for measuring a temperature of the control target object; and a controller for controlling the power supply unit by an ILQ control based on a signal from the temperature sensor so as to set the temperature of the control target object to a preset target temperature.

In accordance with a second aspect of the present invention, there is provided a temperature control device, for use in a processing apparatus for performing a film forming process on a substrate accommodated in a processing chamber by introducing a film forming processing gas into the processing chamber, for performing a temperature control of a processing chamber wall portion, the device including: a plurality of heater units for heating each of a multiplicity of zones into which the processing chamber wall portion is divided; a multiplicity of power supply units for supplying power to each of the plurality of heater units; a number of temperature sensors for measuring the temperature of each of the multiplicity of zones; and a plurality of controllers for controlling a corresponding power supply unit by an ILQ control based on a signal from each temperature sensor to set a temperature of a corresponding zone to a preset target temperature.

In accordance with a third aspect of the present invention, there is provided a temperature control device, for use in a processing apparatus for performing a film forming process on a substrate accommodated in a processing chamber by introducing a film forming processing gas into the processing chamber, for performing a temperature control of a processing chamber wall portion, the device including: a plurality of main heater units installed in a multiplicity of zones into which the processing chamber wall portion is divided, for heating each zone; a multiplicity of sub heater units installed in the vicinity of a wall portion in an inner space of the processing chamber, for heating the processing chamber wall portion; a number of power supply units for supplying power to each of the plurality of main heater units and the multiplicity of sub heater units; a plurality of temperature sensors for measuring a temperature of each of the multiplicity of zones and each of plural portions of the processing chamber wall portion heated by the sub heater units; and a multiplicity of controllers for controlling a corresponding power supply unit by an ILQ control based on a signal from each temperature sensor to set a temperature of a corresponding zone or portion to a preset target temperature.

In accordance with a fourth aspect of the present invention, there is provided a processing apparatus including: a processing chamber; a substrate supporting table for supporting thereon a substrate in the processing chamber; a device for performing a preset process on the substrate in the processing chamber; and a temperature control device for performing a temperature control on a predetermined portion of the processing chamber or a predetermined member therein as a control target object, wherein the temperature control device includes: a heater unit for heating the control target object; a power supply unit for supplying power to the heater unit; a temperature sensor for measuring a temperature of the control target object; and a controller for controlling the power supply unit by an ILQ control based on a signal from the temperature sensor so as to set a temperature of the control target object to a preset target temperature.

In accordance with a fifth aspect of the present invention, there is provided a processing apparatus including: a processing chamber; a substrate supporting table for supporting thereon a substrate in the processing chamber; a gas supply unit for supplying a film forming processing gas into the processing chamber; a heating device for heating the substrate supporting table; and a temperature control device for performing a temperature control of a processing chamber wall portion, wherein the processing apparatus performs a film forming process on the substrate, and the temperature control device includes: a plurality of heater units for heating each of a multiplicity of zones into which the processing chamber wall portion is divided; a multiplicity of power supply units for supplying power to each of the plurality of heater units; a number of temperature sensors for measuring a temperature of each of the multiplicity of zones; and a plurality of controllers for controlling a corresponding power supply unit by an ILQ control based on a signal from each temperature sensor to set a temperature of a corresponding zone to a preset target temperature.

In accordance with a sixth aspect of the present invention, there is provided a processing apparatus including: a processing chamber; a substrate supporting table for supporting thereon a substrate in the processing chamber; a gas supply unit for supplying a film forming processing gas into the processing chamber; a heating device for heating the substrate supporting table; and a temperature control device for performing a temperature control of a processing chamber wall portion, wherein the processing apparatus performs a film forming process on the substrate, and the temperature control device includes: a plurality of main heater units installed in a multiplicity of zones into which the processing chamber wall portion is divided, for heating each of the multiplicity of zones; a multiplicity of sub heater units installed in the vicinity of a wall portion in an inner space of the processing chamber, for heating the processing chamber wall portion; a number of power supply units for supplying power to each of the plurality of main heater units and the multiplicity of sub heater units; a plurality of temperature sensors for measuring a temperature of each of the multiplicity of zones and each of plural portions of the processing chamber wall portion heated by the sub heater units; and a multiplicity of controllers for controlling a corresponding power supply unit by an ILQ control based on a signal from each temperature sensor to set a temperature of a corresponding zone or portion to a preset target temperature.

In accordance with the second, third, fifth and sixth aspects, the multiplicity of zones of the processing chamber may be arranged along a circumferential direction of the processing chamber.

In accordance with the fifth and sixth aspects, the processing apparatus may further include: a plasma generating device for exciting a processing gas into plasma in the processing chamber, and in this case, the plasma generating device, which excites the processing gas into the plasma by introducing microwave into the processing chamber, may be used.

In accordance with the first to sixth aspects, the controller may include a setting device for setting the target temperature, and an ILQ control device for outputting a control signal so as to set a temperature measured by the temperature sensor to the target temperature, and in this case, it is desirable that the ILQ control device includes a state observer.

In accordance with a seventh aspect of the present invention, there is provided a processing apparatus including: a processing chamber; a substrate supporting table for supporting thereon a substrate in the processing chamber; a gas supply unit for supplying a film forming processing gas into the processing chamber; and a temperature control device for performing a temperature control of the substrate supporting table, wherein the processing apparatus performs a film forming process on a substrate, and the temperature control device includes: a plurality of heater units for heating each of a multiplicity of zones into which the substrate supporting table is divided; a multiplicity of power supply units for supplying power to each of the plurality of heater units; a number of temperature sensors for measuring a temperature of each of the multiplicity of zones; and a plurality of controllers for controlling a corresponding power supply unit by an ILQ control based on a signal from each temperature sensor to set a temperature of a corresponding zone to a preset target temperature.

In accordance with the present invention, since the temperature control of the control target is carried out by modelizing the control target and the external factors by using the ILQ control method, the optimal parameters can be determined uniquely by using the inverse problem of the optimal regulator, so that error and input can be minimized, and response can also be specified. Accordingly, the follow-up property to the target value is excellent and the dynamic error can be minimized. Moreover, unlike the PID control, since no overshoot occurs and control amount can be optimized in consideration of the capacity of the power supply, energy efficiency is raised in comparison with the case of the PID control. Further the ILQ control has a good robustness, and control efficiency can be maintained even in case that the control target model varies within a certain range.

Further, by dividing the wall portion of the processing chamber into the plurality of zones and controlling the temperature of each zone with the multi-channel ILQ control, interference between the channels can be prevented, and a high-precision control can be performed without being influenced by neighboring channels, thus improving uniformity of temperatures between the channels.

Further, in such temperature control of the wall portion of the processing chamber, by installing multi-channel sub heaters adjacent to the processing chamber in a space formed therein, the temperature control can be performed more accurately. In the conventional PID control, it was difficult to perform the control independently because the heaters were installed adjacent to each other. However, since the interference between the neighboring channels can be prevented by the ILQ control, the effect of such sub heaters can be improved so that the control can be performed more accurately.

### BRIEF DESCRIPTION OF THE DRAWINGS

The disclosure may best be understood by reference to the following description taken in conjunction with the following figures:

FIG. 1 is a schematic cross sectional view of a microwave plasma processing apparatus to which a temperature control device in accordance with an embodiment of the present invention is applied;

FIG. 2 is a configuration of a planar antenna used in the plasma processing apparatus of FIG. 1;

FIG. 3 is a horizontal cross sectional view of the temperature control device of the plasma processing apparatus of FIG. 1;

FIG. 4 presents a block diagram of a controller for use in the temperature control device of the plasma processing apparatus of FIG. 1;

FIG. 5 is a block diagram of the controller of FIG. 4;

FIG. 6 is a schematic cross sectional view of a microwave plasma processing apparatus to which a temperature control device in accordance with another embodiment of the present invention is applied;

FIG. 7 shows a horizontal cross sectional view of the temperature control device of the plasma processing apparatus of FIG. 6;

FIG. 8 is a graph showing an example of a temperature response when using the temperature control device of the present invention; and

FIG. 9 is a graph showing a power input to a heater when using the temperature control device of the present invention.

### DETAILED DESCRIPTION OF THE INVENTION

Hereinafter, embodiments of the present invention will be described in detail with reference to the accompanying drawings. Here, description will provided for an example case of applying a temperature control device of the present invention to a chamber wall (a housing unit) of a microwave plasma processing apparatus.

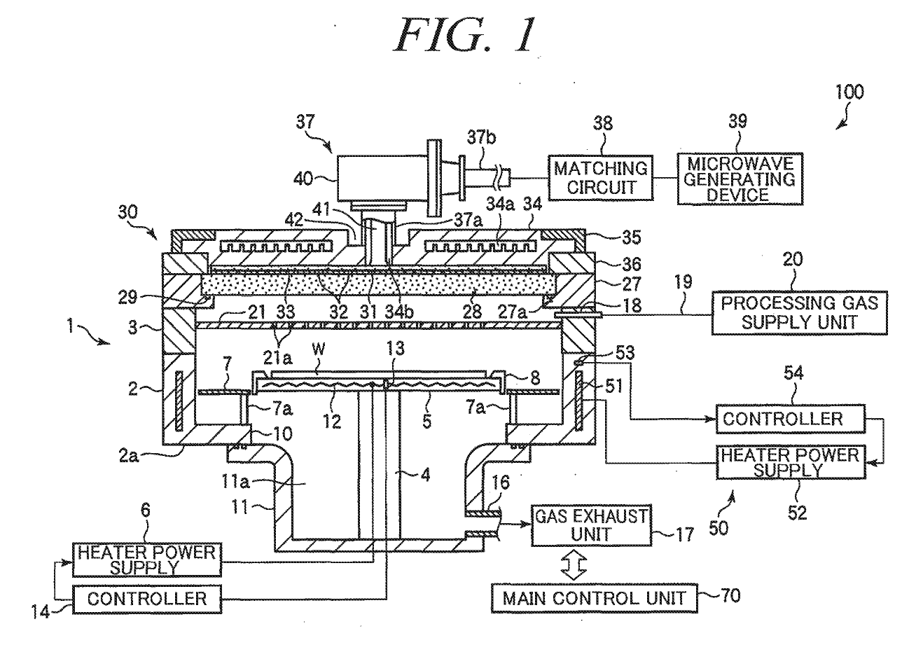

FIG. 1 is a schematic cross sectional view showing a microwave plasma processing apparatus to which a temperature control device in accordance with an embodiment of the present invention is applied. The microwave plasma processing apparatus 100 is configured as a plasma film forming apparatus which generates microwave plasma having high density and low electron temperature by introducing microwave into a processing chamber from a planar antenna having a plurality of slots, e.g., a RLSA (Radial Line Slot Antenna), and performs a film forming process by using the microwave plasma.

The plasma processing apparatus 100 includes an approximately cylindrical chamber (processing vessel) 1 which is air-tightly sealed and grounded, for loading a wafer W therein. The chamber 1 is made of a metal material such as aluminum or stainless steel, and it includes a housing 2 constituting a lower portion thereof and a chamber wall 3 disposed on the housing 2. Further, a microwave introduction unit 30 for introducing microwave into a processing space is disposed at a top portion of the chamber 1 such that it can be opened or closed.

Provided in an approximately central portion of a bottom wall 2a of the housing 2 is a circular opening 10, and coupled to the bottom wall 2a so as to communicate with the opening 10 is a gas exhaust chamber 11 protruding downward, for evacuating the inside of the chamber 1 uniformly.

A susceptor 5 for horizontally supporting the wafer W, which is a target object to be processed, thereon is installed in the housing 2 by being sustained on a cylindrical supporting member 4 extending upward from the center of the bottom portion of the gas exhaust chamber 11. The susceptor 5 and the supporting member 4 are made of ceramics such as AlN or the like. A guide ring 8 for guiding the wafer W is installed at an outer periphery portion of the susceptor 5. Further, the susceptor 5 has a resistance heater 12 embedded therein. As power is supplied to the heater 12 from a heater power supply 6, the susceptor 5 is heated, whereby the wafer W thereon is also heated. The temperature of the susceptor 5 is detected by a thermocouple 13 inserted therein, and a temperature controller 14 controls the heater power supply 6 based on a signal from the thermocouple 13 so as to carry out a temperature control within a temperature ranging from, e.g., a room temperature to about 100° C.

Further, wafer supporting pins (not shown) for supporting and elevating the wafer W are installed in the susceptor 5 such that they can be projected from and retracted into the surface of the susceptor 5. Further, a baffle plate 7 for evacuating the inside of the chamber 1 uniformly is installed along the outer periphery of the susceptor 5 in an annular shape. The baffle plate 7 is supported by a plurality of supporting columns 7a.

A gas exhaust pipe 16 is coupled to a lateral side of the gas exhaust chamber 11, and a gas exhaust unit 17 including a high speed vacuum pump is connected with the gas exhaust pipe 16. By operating the gas exhaust unit 17, a gas inside the chamber 1 is uniformly discharged into a space 11a within the gas exhaust chamber 11 and is then exhausted via the gas exhaust pipe 16. As a result, the inside of the chamber 1 can be depressurized to a specific vacuum level at a high speed.

Installed in the sidewall of the housing 2 are a loading/unloading port (not shown) through which loading/unloading of the wafer W is carried out; and a gate valve (not shown) for opening and closing the loading/unloading port.

Installed at an upper sidewall portion of the chamber 1 is a gas introduction nozzle 18 for introducing a processing gas into the chamber 1, and connected with the gas introduction nozzle 18 is a processing gas supply unit 20 for supplying a film forming processing gas via a pipe 19. The processing gas from the processing gas supply unit 20 is introduced into the upper portion of the chamber 1 via the pipe 19 and the gas introduction nozzle 18.

In the upper portion of the chamber 1, there is installed horizontally a shower plate 21 provided with a number of gas through holes 21a. The processing gas, which is introduced into the chamber 1 from the gas introduction nozzle 18 and excited by microwave, is supplied toward the wafer W in a shower shape through the gas through holes 21a of the shower plate 21.

The chamber 1 has a top opening, and the microwave introduction unit 30 is installed to cover the opening hermetically. The microwave introduction unit 30 can be opened and closed by a non-illustrated opening/closing mechanism.

The microwave introduction unit 30 includes a transmitting plate 28, a planar antenna 31 and a wavelength shortening member 33 arranged in the above-mentioned sequence from the susceptor 5 side. They are covered by a shield member 34 and fixed to a supporting member of an upper plate 27 via an O-ring by an annular pressing ring 35 having an L-shaped cross section via a supporting member 36. When the microwave introduction unit 30 is closed, the top end of the chamber 1 and the upper plate 27 are sealed by a sealing member (not shown), and the microwave introduction unit 30 is supported on the upper plate 27 via the transmitting plate 28 as will be described later.

The transmitting plate 28 is made of a dielectric material such as quartz or ceramics, and it functions as a microwave introducing window for transmitting the microwave so as to introduce it into the processing space inside the chamber 1. The transmitting plate 28 is airtightly supported by a protruding portion 27a at the inner peripheral surface of the upper plate 27 which is arranged in a ring shape at the lower outer periphery of the microwave introduction unit 30, via a sealing member 29. Accordingly, the inside of the chamber 1 can be hermetically maintained when the microwave introduction unit 30 is kept closed.

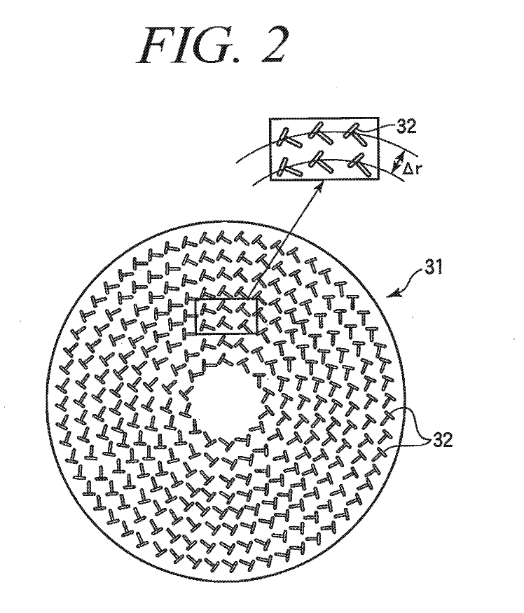

The planar antenna 31 having a circular plate shape is provided above the transmitting plate 28 so as to face the susceptor 5. The planar antenna 31 is engaged with a top end portion of the sidewall of the chamber 1. The planar antenna 31 is made of a conductor, e.g., an aluminum plate or a copper plate coated with gold, and has a plurality of microwave radiation holes (slots) 32 formed therethrough in a specific pattern. That is, the planar antenna 31 constitutes a RLSA antenna. Each microwave radiation hole 32 has an elongated groove shape, as shown in FIG. 2, and adjacent microwave radiation holes 32 are arranged to intersect each other, typically, arranged to be at right angles to each other (i.e., in a T shape). The plurality of microwave radiation holes 32 is concentrically arranged. The length or the arrangement interval of the microwave radiation holes 32 is determined depending on the wavelength of the microwave, or the like. Further, in FIG. 2, if the interval Δr (which is the same as the interval between the center of the planar antenna 31 and the innermost microwave radiation holes 32) between the adjacent microwave radiation holes 32 that are concentrically disposed is set to be equal to the wavelength of the microwave passing through the wavelength shortening plate 33, and if the interval between the center of the planar antenna 31 and the innermost microwave radiation holes 32 is set to be Δr, this configuration is desirable since a strong electric field can be radiated therefrom. In the shown example, microwave radiation holes in 4 turns are arranged. Further, the microwave radiation holes 32 may have another shape, e.g., a circular shape, an arc shape or the like. Further, the microwave radiation holes 32 can be arranged in another pattern, e.g., a spiral pattern, a radial pattern or the like, without being limited to the concentric circular pattern.

The wavelength shortening plate 33 made of a dielectric material having a dielectric constant greater than that of a vacuum is provided on the top surface of the planar antenna 31. The wavelength shortening plate 33 has a function of shortening the wavelength of the microwave in the wavelength shortening plate in comparison with the wavelength of the microwave in the vacuum.

The shield lid 34 made of a metal material, e.g., aluminum, stainless steel or the like is provided on the top surface of the chamber 1 to cover the planar antenna 31 and the wavelength shortening plate 33.

A cooling water path 34a is formed in the shield lid 34, so that the planar antenna 31, the microwave transmitting plate 28, the wavelength shortening plate 33 and the shield lid 34 can be cooled by passing cooling water through the cooling water path 34a. Further, the shield lid 34 is grounded, and has therein a heater (not illustrated) for temperature control.

The shield lid 34 has an opening 42 at the center of a top wall thereof, and a waveguide 37 is connected to the opening. A microwave generating device 39 is connected with an end portion of the waveguide 37 via a matching circuit 38. Accordingly, microwave having a frequency of, e.g., about 2.45 GHz, which is generated from the microwave generating device 39, is propagated to the planar antenna 31 via the waveguide 37. Alternatively, the microwave may have a frequency of about 8.35 GHz, 1.98 GHz or the like.

The waveguide 37 includes a coaxial waveguide 37a having a circular cross section and extending upward from the opening 42 of the shield lid 34, and a rectangular waveguide 37b having a rectangular cross section and connected with an upper end portion of the coaxial waveguide 37a while extending in a horizontal direction. A mode converter 40 is installed at an end portion of the rectangular waveguide 37b on the side making contact with the coaxial waveguide 37a. An internal conductor 41 is extended in the center of the coaxial waveguide 37a, and a lower portion of the internal conductor 41 is fixedly connected to the center of the planar antenna 31.

As for the housing 2 of the chamber 1, the temperature of its wall portion is controlled by a temperature control device 50 in accordance with the embodiment of the present invention. In the plasma film forming apparatus as in the present embodiment, since it is desirable to prevent deposition on the chamber wall as much as possible, the temperature of the wall portion of the housing 2 constituting the major part of the chamber 1 is regulated at a temperature level of, e.g., about 150° C., at which the deposition hardly occurs. The temperature control device 50 divides the wall portion of the housing 2 into a plurality of zones, and performs a temperature control for each zone. The temperature control device 50 includes a plurality of neater units 51 installed in each zone; a plurality of heater power supplies 52 (though only one is illustrated in FIG. 1) for supplying power to a plurality of heater units 51, respectively; a plurality of thermocouples 53 (though only one is illustrated in FIG. 1) serving as a temperature sensor for measuring the temperature of each zone; and a plurality of controllers 54 (though only one is illustrated in FIG. 1) for controlling the temperature of each zone of the housing 2 based on a measurement signal transmitted from each thermocouple 53.

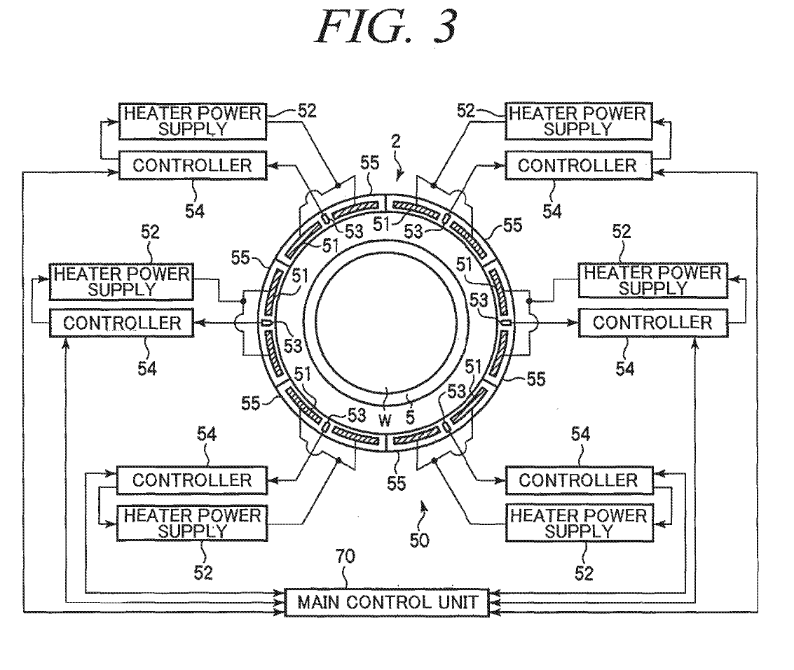

As shown in FIG. 3, the wall portion of the housing 2 is divided into a plurality of zones, e.g., 6 zones (regions) 55 along the circumferential direction of the housing 2, and each zone 55 is provided with the heater unit 51, the heater power supply 52, the thermocouple 53 and the controller 54.

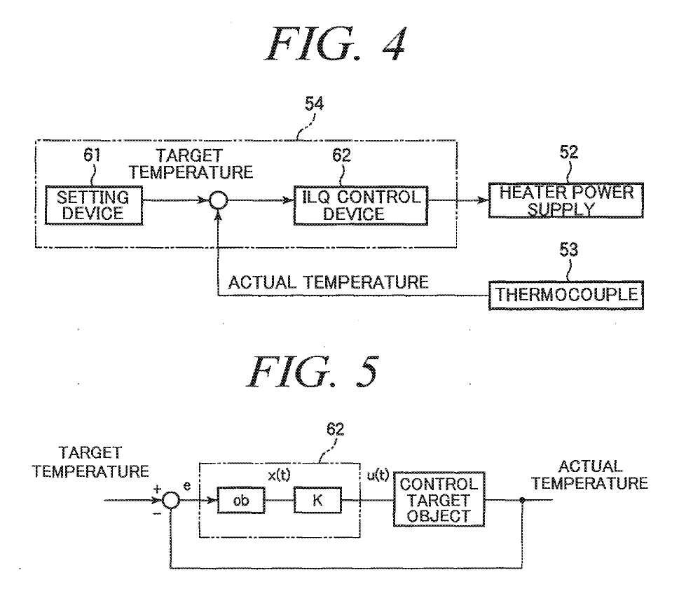

The controller 54 includes, as shown in FIG. 4, a setting device 61 for setting a target temperature and an ILQ control device 62 for transmitting a control signal to the heater power supply 52 based on the target temperature and the signal from the thermocouple.

The ILQ control device 62 is a controller employing an ILQ (Inverse Linear Quadratic) control method based on a modern control theory. According to the ILQ control method, a control target and external factors are modelized (as state space models) and an optimal feedback law for these models are determined uniquely by an ILQ design method. Here, the ILQ design method is a servo design method using an inverse problem of an optimal regulator. For example, the design of a control system based on the ILQ control is disclosed in Fujii, Shimomura: “Generalization of ILQ Optimum Servo System Design Method,” Proceedings of System Control Information Society, Vol. 1 No. 6, pp. 194-203 (1988).

FIG. 5 illustrates a block diagram of such control system. Here, ob stands for a state observer, and K denotes a feedback matrix. Further, u indicates a control input, and x represents a property of a model.

An optimal regulator problem is a problem for calculating an input u(t) which minimizes a secondary evaluation function (target function) J provided in equation (1) below for a control target model, and its solution is obtained as u(t)=Kx(t).

$$\begin{matrix}[ Numerical Formula 1 ] & \\ j = {\int }_{0}^{∞} ( {e}^{T} Q e + {u}^{T} Ru ) d t & ( 1 )\end{matrix}$$

In this equation (1), e denotes a temperature error, and Q and R denote weight matrixes.

Here, as the control target model, equations (2) and (3) using partial space models, which are linearized mathematical models, are applied.

[Numerical Formula 2]

X=Ax+Bu (2)

Y=Cx (3)

Here, A, B and C stand for matrixes.

In the optimal regulator problem (sequence problem) the weight matrixes of the secondary evaluation function are first selected, and a state feedback gain is then calculated by solving a Riccati equation numerically. However, the selection of the weight matrixes has not been definitely related with engineering specifications such as overshoot of transient response, setting time, or the like, and many trials and errors or repetitive works are required to obtain a desirable control device. The ILQ design method, however, uses the inverse problem of the optimal regulator, as described above. A necessary and sufficient condition for allowing a state feedback to be an optimal control is that there exist appropriate regular matrixes V and E and an appropriate real matrix for the gain K, and an equation using these matrixes is made for the gain K. From this equation, the optimal gain capable of satisfying the engineering specifications can be obtained relatively easily

Further, the temperature of a wall portion of the chamber wall 3 is also controlled by a similar temperature control device, though not shown. Further, though not illustrated either, the shower plate 21 is subjected to air cooling and the temperature thereof is controlled by regulating the flow velocity of air in a certain temperature by means of a similar temperature control device. As for the shield lid 34, its temperature is controlled by regulating the flow velocity of the cooling water flowing through the cooling water path 34a, as described above, and by controlling an output of a non-illustrated heater by means of a similar control device. As for the control temperatures, the wall portion of the chamber wall 3 and the shower plate 21 are controlled at, e.g., about 200° C., while the shield lid 34 is controlled at about 100° C.

As for the temperature control of the susceptor 5, multi-channel, for example, three-channel control is performed as well, and an ILQ control similar to that for the housing 2 may be employed. The temperature of the susceptor 5 is set to be an optimal value in the temperature range of, e.g., about 300 to 400° C. depending on the kind of a target film to be formed.

Each component of the plasma processing apparatus 100 is controlled by a main control unit 70. The main control unit 70 includes a program storage unit for storing therein process recipes or control programs for performing preset controls; a process controller for actually controlling each component based on the control programs; and a user interface including a keyboard, a display, or the like.

Specifically, the main control unit 70 controls the microwave generating device 39, the matching circuit 38, the microwave introduction unit 30, the supply and exhaust of the gas, the gate valve, a driving system of elevating pins or the like, the temperature controller, and so forth.

Now, an operation of the plasma processing apparatus 100 having the above-described configuration will be explained. First, the wafer W is loaded into the chamber 1 and mounted on the susceptor 5. Then, the film forming processing gas is introduced into the upper portion of the chamber 1 from the processing gas supply unit 20.

Subsequently, the microwave generated from the microwave generating device 39 is guided to the waveguide 37 via the matching circuit 38 and then is supplied to the planar antenna 31 via the rectangular waveguide 37b, the mode converter 40, the coaxial waveguide 37a and the internal conductor 41 in sequence. Thereafter, the microwave is radiated through the slots of the planar antenna 31 into the chamber 1 via the transmitting plate 28.

The microwave propagates in the rectangular waveguide 37b in a TE mode. The TE mode of the microwave is converted into a TEM mode in the mode converter 40, and the microwave in the TEM mode propagates through the coaxial waveguide 37a toward the planar antenna 31. An electromagnetic field is formed in the chamber 1 by the microwave radiated from the planar antenna 31 into the chamber 1 via the transmitting plate 28, thereby converting the processing gas into plasma. Then, the plasma of the processing gas is uniformly supplied to the wafer W on the susceptor 5 after passing through the shower plate 21.

By radiating the microwave through the plurality of slot holes 32 of the planar antenna 31, the plasma has a high density ranging from about 1×10¹⁰ to 5×10¹²/cm³, and it becomes to have a low electron temperature of about 1.5 eV in the vicinity of the wafer W. Accordingly, by allowing this plasma to act on the wafer W, a plasma process can be performed while suppressing plasma damage.

When a certain film is formed on the wafer W by the film forming processing gas converted into the plasma, the susceptor 5 is controlled at a temperature suitable for the film formation. Meanwhile, though the wall portion of the chamber 1, especially, the wall portion of the housing 2 is controlled at a temperature of, e.g., about 150° C. at which deposition hardly occurs, the wall portion of the housing 2 is of a large size, so that 6-channel temperature control is performed to control the temperature of the wall portion of the housing 2 with a high precision, as shown in FIG. 3.

As for such control, if a conventional PID control, widely used, is performed to carry out the temperature control, it is difficult to reach a target temperature quickly and a dynamic control error occurs. Further, non-uniformity between the channels or interference between the channels also occurs if the multi-channel temperature control is performed, thus making it difficult to achieve a highly precise temperature control.

To the contrary, in the present embodiment, since the temperature control is carried out by modelizing the control target and the external factors by using the ILQ control device 62 based on the ILQ design method, a highly precise control can be performed. That is, in the ILQ control, by using the inverse problem of the optimal regulator, the optimal parameters can be determined uniquely, so that error and input can be minimized, and response can also be specified. Accordingly, the follow-up property to the target value is excellent and the dynamic error can be minimized. Further, even in case of the multi-channel control as in the present embodiment, interference between the channels can be prevented, and a high-precision control can be performed without being influenced by neighboring channels, thus improving uniformity of temperatures between the channels. Moreover, unlike the PID control, since no overshoot occurs and control amount can be optimized in consideration of the capacity of the power supply, about 20% of energy reduction can be achieved in comparison with the case of the PID control. Further, the ILQ control has a good robustness. That is, control efficiency can be maintained even in case that the control target model varies within a certain range.

Actually, the wall portion of the housing 2 was divided in 6 channel zones, and the temperature control of the present embodiment was compared with that of the conventional PID control. As a result, equithermal property of about ±15° C. was obtained over the entire wall surface in the conventional PID control, whereas equithermal property of about ±5° C. could be obtained in the ILQ control of the present embodiment while performing non-interference control.

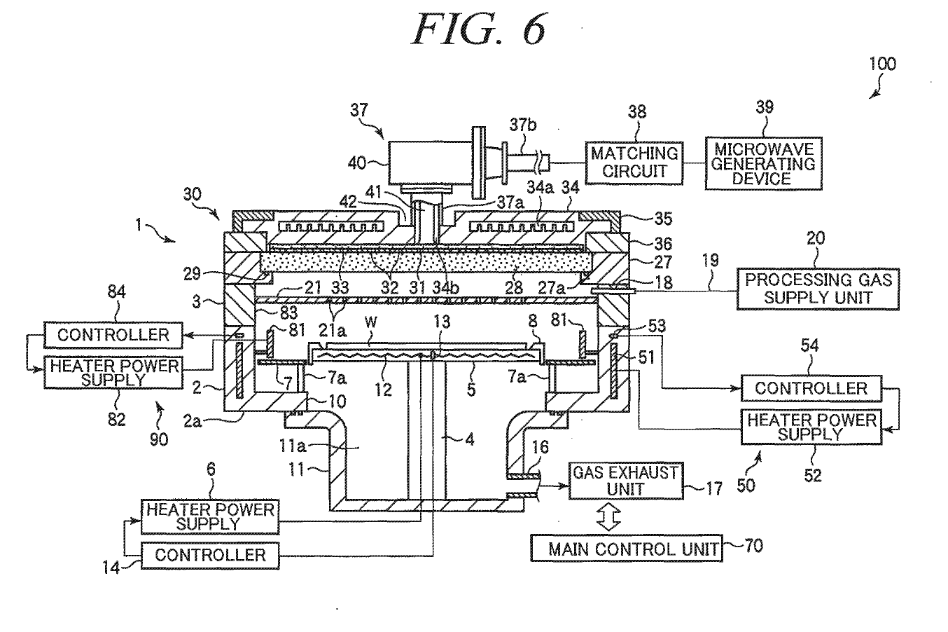

Now, a temperature control device in accordance with another embodiment of the present invention will be explained. FIG. 6 is a schematic cross sectional view of a microwave plasma processing apparatus to which the temperature control device in accordance with another embodiment of the present invention is applied. In the present embodiment, for the temperature control of the housing 2 of the chamber 1, there is installed a temperature control device 90 including 4 channels of sub heater units 81 (though only 2 channels are shown in FIG. 6) in addition to the above-described 6 channels of heater units 51. Since the other configurations are identical with those described in FIG. 1, components identical with those in FIG. 1 will be assigned like reference numerals, and description thereof will be omitted.

Even in case of dividing the wall portion of the housing 2 of the chamber 1 into a plurality of zones and performing a temperature control for each of the plurality of zones in the same manner as the embodiment described above, there may arise occasions in which uniformity of temperature control of the housing 2 is insufficient. According to the examination result of the present inventors, was proved effective to install the sub heater units 81 along the inner wall of the housing 2 within the space of the chamber 1. That is, by heating the surface of the inner wall of the housing 2 by means of the sub heater units 81, the temperature of the wall portion of the housing 2 can be regulated more uniformly.

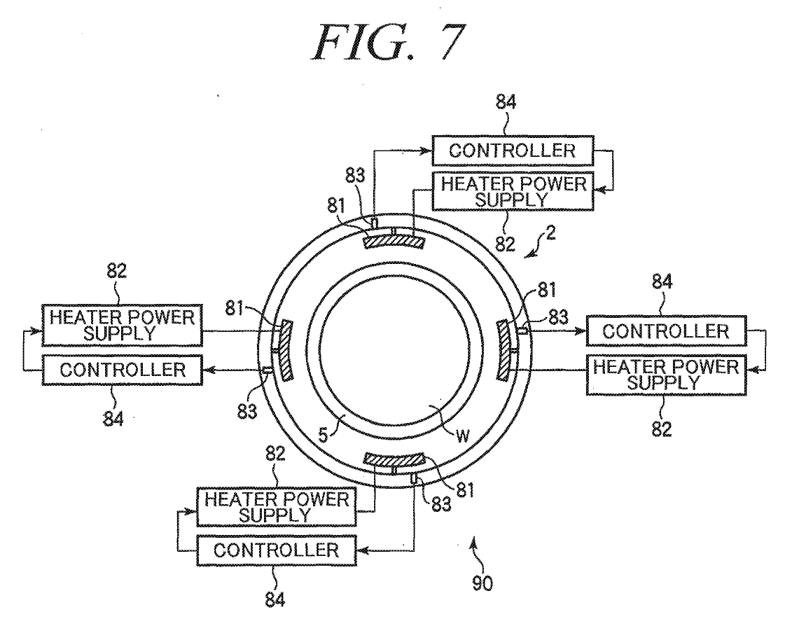

As illustrated in FIG. 7, the temperature control device 90 in this embodiment includes the 4 channels of sub heater units 81; 4 channels of heater power supplies 82 for supplying power to each of the sub heater units 81; 4 channels of thermocouples 83 installed at positions corresponding to the sub heater units 81 on the inner surface of the wall portion of the housing 2; and 4 channels of controllers 84 for controlling the temperature of the inner surface of the wall portion of the housing 2 in addition to the 6 channels of heater units 51; the 6 channels of heater power supplies 52 for supplying power to the 6 channels of heater units 51; the 6 channels of thermocouples 53 for measuring the temperature of each zone; and the 6 channels of controllers 54 for controlling the temperature of each zone, as in the prior embodiment. That is, the temperature control device 90 performs a total of 10-channel temperature controls. Further, illustrations of the heater units 51, the heater power supplies 52, the thermocouples 53, the controllers 54 and the main control unit 70 are omitted in FIG. 7.

In the conventional PID control, if the sub heater units 81 are more closely installed in the chamber 1 besides the heater units 51 in the wall portion of the housing 2, an inter-channel interference problem would occur, resulting in a substantial failure in the temperature control.

However, by using the ILQ control device 62 as the controllers 54 and 84, non-interference can be achieved, so that a higher-precision control can be carried out by using the sub heater units 81.

Moreover, by installing the heaters in the inner space of the chamber 1, there can be obtained a function of adjusting the microwave plasma by controlling ion distribution or plasma flow.

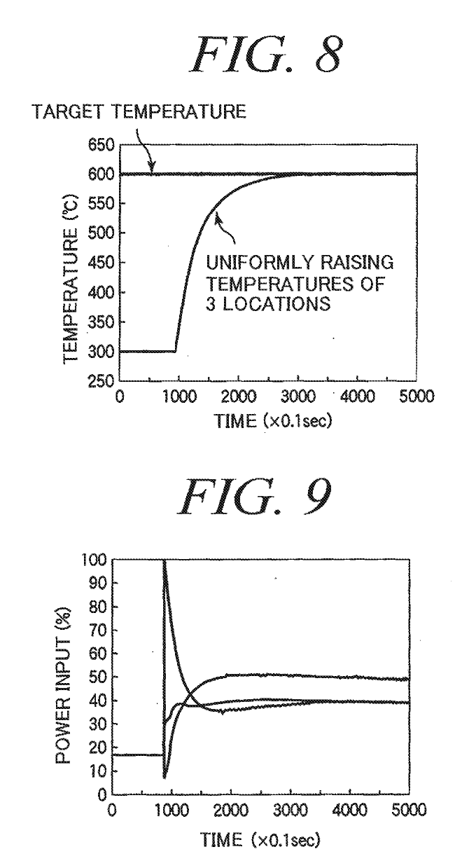

Now, an experiment result of raising the temperature of the wafer on the susceptor by using the ILQ control will be described. Here, by using 3 channels of controllers, the susceptor (wafer) was heated from about 300° C. to about 600° C. by using the above-described ILQ control device for each controller. The heater of the susceptor made of AlN is divided into three zones concentrically, and a temperature response and a power input to the heater at this time are shown in FIGS. 8 and 9, respectively. As shown in FIG. 8, it were found that the temperatures were raised promptly and uniformly for the three channels, and the temperatures reached a target temperature with no overshoot. Further, as can be seen from FIG. 9, it was also found that energy efficiency is high in view of the fact that the time for inputting a high power is short. Further, since the temperature control is carried out with an optimal control amount in consideration of the power supply capacity (in FIG. 9, 2 kW as 100%), the breakdown of the hardware such as the power supply can be reduced. Further, even in case that one of the sensors such as the thermocouples or the like is out of order, a feedback control is still possible in the entire system. Accordingly, by using the ILQ control method, not only the success in control but also improvement in the reliability of the entire system can be achieved.

Further, it should be noted that the present invention is not limited to the above-described embodiments but can be modified in various ways. For example, though the embodiments have been described for the case of applying the present invention to the film forming apparatus configured as the microwave plasma processing apparatus, the present invention can also be applied to any kind of processing apparatuses which require a temperature control. Furthermore, although the temperature control on the wall portion of the housing of the chamber has been mainly described, the present invention is not limited thereto, but can be applied to a temperature control on another portion of the chamber wall or another member inside or outside of the chamber. For example, in the temperature control of the above-described shield lid 34, there is a need to regulate its temperature at a certain level by warming the shield lid with the heater when the plasma is generated in the chamber, while cooling the shield lid with the cooling water when the plasma is not generated in the chamber. In such case, in the conventional PID control, oscillation of the control system is caused, so that it is impossible to achieve both the heating and the cooling controls. In that case, if the ILQ control is applied, the control system can perform appropriate heating and cooling controls with no oscillation.

In addition, though the above embodiments have been described for performing the 6 channels of controls for the housing wall portion of the chamber, the present invention is not limited thereto, and the number of channels can be varied. Further, though the sub heater units are installed in the 4 channels, the number of channels of the sub heater units is not limited thereto, either.

Furthermore, though the power supply is installed for each of the plurality of heater units and sub heater units, it may be also possible to use a power supply having a multiplicity of power supplying units and to supply power to the heater units or the sub heater units from each power supply unit.

Moreover, though the case of using the semiconductor wafer as the target substrate is illustrated in the above embodiments, it is not limited thereto and it may be possible to use another type of substrate such as a glass substrate for FPD or the like as the target substrate. The above description of the present invention is provided for the purpose of illustration, and it would be understood by those skilled in the art that various changes and modifications may be made without changing technical conception and essential features of the present invention. Thus, it is clear that the above-described embodiments are illustrative in all aspects and do not limit the present invention.

The scope of the present invention is defined by the following claims rather than by the detailed description of the embodiment. It shall be understood that all modifications and embodiments conceived from the meaning and scope of the claims and their equivalents are included in the scope of the present invention.

What is claimed is:

1. A temperature control device, for use in a processing apparatus for performing a preset process on a substrate accommodated in a processing chamber, for performing a temperature control of a predetermined portion of the processing chamber or a predetermined member therein as a control target object, the device comprising:
a heater unit for heating the control target object;
a power supply unit for supplying power to the heater unit;
a temperature sensor for measuring a temperature of the control target object; and
a controller for controlling the power supply unit by an ILQ control based on a signal from the temperature sensor so as to set the temperature of the control target object to a preset target temperature.

2. A temperature control device, for use in a processing apparatus for performing a film forming process on a substrate accommodated in a processing chamber by introducing a film forming processing gas into the processing chamber, for performing a temperature control of a processing chamber wall portion, the device comprising:
a plurality of heater units for heating each of a multiplicity of zones into which the processing chamber wall portion is divided;
a multiplicity of power supply units for supplying power to each of the plurality of heater units;
a number of temperature sensors for measuring the temperature of each of the multiplicity of zones; and
a plurality of controllers for controlling a corresponding power supply unit by an ILQ control based on a signal from each temperature sensor to set a temperature of a corresponding zone to a preset target temperature.

3. A temperature control device, for use in a processing apparatus for performing a film forming process on a substrate accommodated in a processing chamber by introducing a film forming processing gas into the processing chamber, for performing a temperature control of a processing chamber wall portion, the device comprising:
a plurality of main heater units installed in a multiplicity of zones into which the processing chamber wall portion is divided, for heating each zone;
a multiplicity of sub heater units installed in the vicinity of a wall portion in an inner space of the processing chamber, for heating the processing chamber wall portion;
a number of power supply units for supplying power to each of the plurality of main heater units and the multiplicity of sub heater units;
a plurality of temperature sensors for measuring a temperature of each of the multiplicity of zones and each of plural portions of the processing chamber wall portion heated by the sub heater units; and
a multiplicity of controllers for controlling a corresponding power supply unit by an ILQ control based on a signal from each temperature sensor to set a temperature of a corresponding zone or portion to a preset target temperature.

4. The temperature control device of claim 2, wherein the multiplicity of zones of the processing chamber is arranged along a circumferential direction of the processing chamber.

5. The temperature control device of claim 1, wherein the controller includes a setting device for setting the target temperature, and an ILQ control device for outputting a control signal so as to set a temperature measured by the temperature sensor to the target temperature.

6. The temperature control device of claim 5, wherein the ILQ control device includes a state observer.

7. A processing apparatus comprising:
a processing chamber;
a substrate supporting table for supporting thereon a substrate in the processing chamber;
a device for performing a preset process on the substrate in the processing chamber; and
a temperature control device for performing a temperature control on a predetermined portion of the processing chamber or a predetermined member therein as a control target object,
wherein the temperature control device includes:
a heater unit for heating the control target object;
a power supply unit for supplying power to the heater unit;
a temperature sensor for measuring a temperature of the control target object; and
a controller for controlling the power supply unit by an ILQ control based on a signal from the temperature sensor so as to set a temperature of the control target object to a preset target temperature.

8. A processing apparatus comprising:
a processing chamber;
a substrate supporting table for supporting thereon a substrate in the processing chamber;
a gas supply unit for supplying a film forming processing gas into the processing chamber;
a heating device for heating the substrate supporting table; and
a temperature control device for performing a temperature control of a processing chamber wall portion,
wherein the processing apparatus performs a film forming process on the substrate, and
the temperature control device includes:
a plurality of heater units for heating each of a multiplicity of zones into which the processing chamber wall portion is divided;
a multiplicity of power supply units for supplying power to each of the plurality of heater units;
a number of temperature sensors for measuring a temperature of each of the multiplicity of zones; and
a plurality of controllers for controlling a corresponding power supply unit by an ILQ control based on a signal from each temperature sensor to set a temperature of a corresponding zone to a preset target temperature.

9. A processing apparatus comprising:
a processing chamber;
a substrate supporting table for supporting thereon a substrate in the processing chamber;
a gas supply unit for supplying a film forming processing gas into the processing chamber;
a heating device for heating the substrate supporting table; and
a temperature control device for performing a temperature control of a processing chamber wall portion,
wherein the processing apparatus performs a film forming process on the substrate, and
the temperature control device includes:
a plurality of main heater units installed in a multiplicity of zones into which the processing chamber wall portion is divided, for heating each of the multiplicity of zones;
a multiplicity of sub heater units installed in the vicinity of a wall portion in an inner space of the processing chamber, for heating the processing chamber wall portion;
a number of power supply units for supplying power to each of the plurality of main heater units and the multiplicity of sub heater units;
a plurality of temperature sensors for measuring a temperature of each of the multiplicity of zones and each of plural portions of the processing chamber wall portion heated by the sub heater units; and
a multiplicity of controllers for controlling a corresponding power supply unit by an ILQ control based on a signal from each temperature sensor to set a temperature of a corresponding zone or portion to a preset target temperature.

10. The processing apparatus of claim 8, wherein the multiplicity of zones is arranged along a circumferential direction of the processing chamber.

11. The processing apparatus of claim 8, further comprising:
a plasma generating device for exciting a processing gas into plasma in the processing chamber.

12. The processing apparatus of claim 11, wherein the plasma generating device excites the processing gas into the plasma by introducing microwave into the processing chamber.

13. The processing apparatus of claim 7, wherein the controller includes:
a setting device for setting the target temperature; and
an ILQ control device for outputting a control signal so as to set a temperature measured by the temperature sensor to the target temperature.

14. The processing apparatus of claim 13, wherein the ILQ control device includes a state observer.

15. A processing apparatus comprising:
a processing chamber;
a substrate supporting table for supporting thereon a substrate in the processing chamber;
a gas supply unit for supplying a film forming processing gas into the processing chamber; and
a temperature control device for performing a temperature control of the substrate supporting table,
wherein the processing apparatus performs a film forming process on a substrate, and
the temperature control device includes:
a plurality of heater units for heating each of a multiplicity of zones into which the substrate supporting table is divided;
a multiplicity of power supply units for supplying power to each of the plurality of heater units;
a number of temperature sensors for measuring a temperature of each of the multiplicity of zones; and
a plurality of controllers for controlling a corresponding power supply unit by an ILQ control based on a signal from each temperature sensor to set a temperature of a corresponding zone to a preset target temperature.
